(19) United States
(12) Patent Application Publication
(10) Pub. No.: US 2018/0182063 A1
(43) Pub. Date: Jun. 28, 2018

(54) INFORMATION DISPLAY FOR LINE REPLACEABLE MODULES

(71) Applicant: Hamilton Sundstrand Corporation, Charlotte, NC (US)

(72) Inventors: Gabriel Radulescu, Loves Park, IL (US); Terry L. Johnson, Rockford, IL (US)

(21) Appl. No.: 15/392,056

(22) Filed: Dec. 28, 2016

(51) Int. Cl. G06T 1/60; G06F 3/0485; G09G 5/34; G09G 5/00; G06F 3/023

(52) U.S. Cl. CPC G06T 1/60; G06F 3/0485; G09G 5/34; G09G 2340/0464; G06F 3/023; G09G 2354/00; G09G 5/005

(57) ABSTRACT

A line replaceable module (LRM) includes a non-volatile memory (NVM) comprising LRM state data, a display module operatively connected to the NVM and configured to receive the LRM state data therefrom to format the LRM state data into a display formatted data, and an electronic display operatively connected to the display module to receive the display formatted data to display the display formatted data on the electronic display.

### BACKGROUND

### 1. Field

The present disclosure relates to line replaceable modules, more specifically to information display for line replaceable modules.

### 2. Description of Related Art

Line replaceable modules (LRM) (e.g., for solid state power controllers (SSPCs) for aircraft power distribution) include data (e.g., part number, configuration data) stored thereon which are related to how each LRM will function when plugged in. This data is stored electronically and sometimes may not match the attached printed labels which can lead to misrepresentation of the LRM's true configuration.

Some cases are caused by human error, e.g., by the way the label has not been marked or improperly marked, and whether the label is visibly readable due to text size, text contrast, and object obstruction, for example. The process for screening this issue requires visual inspection more than once to ensure that the configuration data labels correctly matches the information electronically.

Such conventional methods and systems have generally been considered satisfactory for their intended purpose. However, there is still a need in the art for improved information display for LRMs. The present disclosure provides a solution for this need.

### SUMMARY

A line replaceable module (LRM) includes a non-volatile memory (NVM) comprising LRM state data, a display module operatively connected to the NVM and configured to receive the LRM state data therefrom to format the LRM state data into a display formatted data, and an electronic display operatively connected to the display module to receive the display formatted data to display the display formatted data on the electronic display.

The display module can include a field programmable gate array (FPGA). Any other suitable hardware (e.g., circuitry) and/or software systems are contemplated herein for use as the display module.

The LRM can include a push button operatively connected to the electronic display and/or the display module to send at least one of an activation signal or scrolling signal thereto to cause activation of the display and/or to cause scrolling through each item of the display formatted data. In certain embodiments, each time the push button is pressed, a scroll signal can be sent to the electronic display and/or the display module to cause a single scroll step to occur. In certain embodiments, each time the push button is pressed, a toggle scroll signal can be sent to the electronic display and/or the display module to start or stop each item of data successively scrolling.

The electronic display can be positioned on the LRM to face outwardly to be viewed by a user when the LRM is installed on a system. The electronic display and the push button can be disposed on a same face of the LRM, for example.

The LRM can include an external power supply such that the electronic display and/or the display module is powered by a source external to the LRM. For example, the LRM can be configured to operate when an external power supply is connected thereto. In certain embodiments, the LRM can include an electrical port for supplying power thereto from an external source. In certain embodiments, the LRM can include an internal power source operatively connected to the electronic display and/or the display module to power either or both, in addition to or alternatively to an external power supply.

In certain embodiments, the LRM state data can include a part number and/or a serial number. In certain embodiments, the LRM state data can include configuration data. For example, the LRM state data can include FPGA configuration data.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a partial schematic view of an embodiment of a line replaceable module (LRM) in accordance with this disclosure, showing a part number being displayed; and

FIG. 2 is a partial schematic view of the embodiment of an LRM of FIG. 1, showing a serial number being displayed.

### DETAILED DESCRIPTION

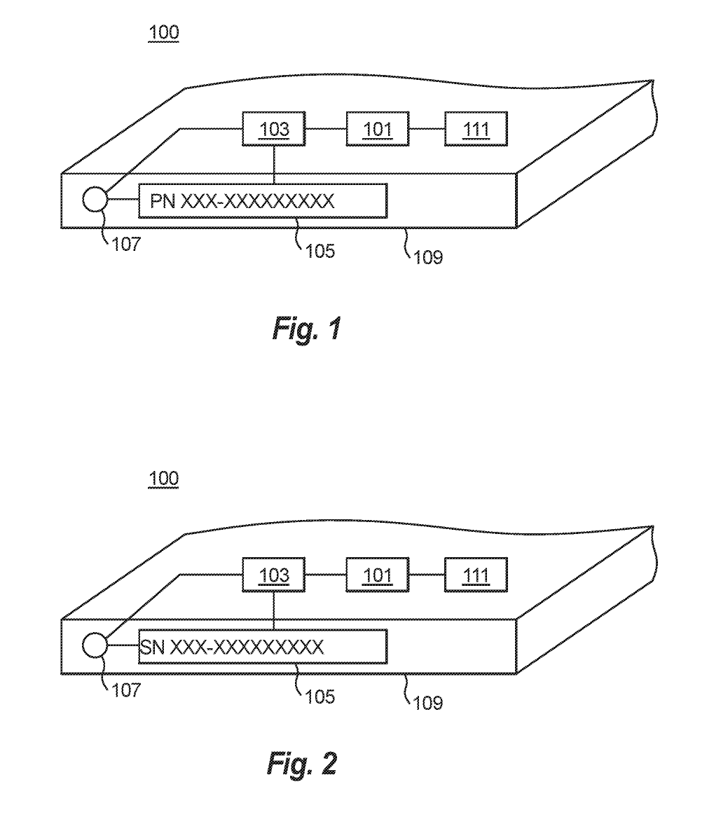

Reference will now be made to the drawings wherein like reference numerals identify similar structural features or aspects of the subject disclosure. For purposes of explanation and illustration, and not limitation, an illustrative view of an embodiment of a line replaceable module (LRM) in accordance with the disclosure is shown in FIG. 1 and is designated generally by reference character 100. Other embodiments and/or aspects of this disclosure are shown in FIG. 2. The systems and methods described herein can be used to provide real time display of LRM state data.

Referring to FIG. 1, a line replaceable module (LRM) 100 includes a non-volatile memory (NVM) 101 comprising LRM state data. The LRM 100 includes a display module 103 operatively connected to the NVM 101 and configured to receive the LRM state data therefrom to format the LRM state data into a display formatted data. The LRM also includes an electronic display 105 operatively connected to the display module 103 to receive the display formatted data to display the display formatted data on the electronic display 105.

The electronic display 105 can be an LCD screen, for example. Any other suitable type of display is contemplated herein.

In certain embodiments, the LRM 100 can be configured for use with one or multiple solid state power controller(s) (SSPC) of an aircraft. In certain embodiments, the display module 103 can include a field programmable gate array (FPGA). Any other suitable hardware (e.g., circuitry) and/or software systems are contemplated herein for use as the display module 103.

The LRM 100 can include a push button 107 and/or any other suitable actuator operatively connected to the electronic display 105 and/or the display module 103 to send at least one of an activation signal or scrolling signal thereto to cause activation of the electronic display 105 and/or to cause scrolling through each item of the display formatted data. In certain embodiments, referring additionally to FIG. 2, each time the push button 107 is pressed, a scroll signal can be sent to the electronic display 105 and/or the display module 103 to cause a single scroll step to occur (e.g., as shown between FIG. 1 and FIG. 2).

In certain embodiments, each time the push button 107 is pressed, a toggle scroll signal can be sent to the electronic display 105 and/or the display module 103 to start or stop each item of data successively scrolling. In this regard, if the push button 107 is pressed, all data will scroll automatically on the electronic display 105. In certain embodiments, a press of the button 107 can cause scrolling or screen on to occur for a set period of time (e.g., 60 seconds).

Scrolling can include a flash display of each item or any other suitable scrolling type. For example, scrolling can include a marquee style scroll from one side to another, one character at a time with each press of the push button 107 (which can allow a user to see each digit/character of information even if only part of the display 105 is visible). In certain embodiments, scrolling characteristics and/or type can be modified by a suitable predetermined user input on the push button 107 (e.g., holding the push button 107 for a predetermined period of time, tapping the button 107 in short succession).

As shown, the electronic display 105 can be positioned on the LRM 100 to face outwardly to be viewed by a user when the LRM 100 is installed on a system. The electronic display 105 and the push button 107 can be disposed on a same face 109 of the LRM 100, for example, for example.

In certain embodiments, the LRM 100 can include an external power supply (e.g., through input/output (I/O) 111) such that the electronic display 105 and/or the display module 103 is powered by a source external to the LRM 100 (e.g., by power supplied to the LRM 100). In certain embodiments, the LRM 100 can include an internal power source (not shown) operatively connected to the electronic display 105 and/or the display module 103 to power either or both, in addition to or alternatively to an external power supply. Any suitable power scheme is contemplated herein.

In certain embodiments, as shown in FIGS. 1 and 2, the LRM state data can include a part number and/or a serial number. In certain embodiments, the LRM state data can include configuration data. For example, the LRM state data can include FPGA configuration data of an FPGA of the LRM 100. The LRM state data can include any other suitable data appreciated by those having ordinary skill in the art, e.g., software part number(s) or LRM type identification number.

As described above each LRM 100 includes a memory that stores data. Certain embodiments also include an FPGA. The data can be pulled by FPGA from the memory to be displayed on the electronic display. Certain embodiments utilize a mini LCD or LED screen that displays the LRM data stored electronically when requested by pushing a button on the front of the LRM. Each set of information can be displayed and cycled through for any suitable time interval (e.g., a total time of 60 seconds).

Embodiments minimize/eliminate the data errors shown on the printed label since the actual data stored can be shown on the electronic display. The data can display in a manner where the text size and contrast would be easy to read and have the ability to scroll the text to maneuver around obstructed objects. Embodiments eliminate the use of remarking and printing new labels anytime the configuration is modified.

As will be appreciated by those skilled in the art, aspects of the present disclosure may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein. The methods and systems of the present disclosure, as described above and shown in the drawings, provide for LRM systems with superior properties. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A line replaceable module (LRM), comprising:
a non-volatile memory (NVM) comprising LRM state data;
a display module operatively connected to the NVM and configured to receive the LRM state data therefrom to format the LRM state data into a display formatted data; and
an electronic display operatively connected to the display module to receive the display formatted data to display the display formatted data on the electronic display.

2. The LRM of claim 1, wherein the display module includes a field programmable gate array (FPGA).

3. The LRM of claim 2, wherein the electronic display is positioned on the LRM to face outwardly to be viewed by a user when the LRM is installed on a system

4. The LRM of claim 3, further comprising a push button operatively connected to the electronic display and/or the display module to send at least one of an activation signal or scrolling signal thereto to cause activation of the display and/or to cause scrolling through each item of the display formatted data.

5. The LRM of claim 4, wherein each time the push button is pressed, a scroll signal is sent to the electronic display and/or the display module to cause a single scroll step to occur.

6. The LRM of claim 4, wherein each time the push button is pressed, a toggle scroll signal is sent to the electronic display and/or the display module to start or stop each item of data successively scrolling.

7. The LRM of claim 4, wherein the electronic display and the push button are disposed on a same face of the LRM.

8. The LRM of claim 1, wherein the LRM is configured to operate when an external power supply is connected thereto.

9. The LRM of claim 8, further comprising an electrical port for supplying power thereto from an external source.

10. The LRM of claim 1, further comprising an internal power source operatively connected to the electronic display and/or the display module to power either or both.

11. The LRM of claim 1, wherein the LRM state data includes a part number.

12. The LRM of the claim 1, wherein the LRM state data includes a serial number.

13. The LRM of claim 1, wherein the LRM state data includes configuration data.

14. The LRM of claim 13, wherein the LRM state data includes FPGA configuration data.
